(19) United States
(12) Patent Application Publication
(10) Pub. No.: US 2016/0069528 A1
(43) Pub. Date: Mar. 10, 2016

(54) LIGHTING MODULE FOR MOTOR VEHICLE HEADLIGHT, HEADLIGHT EQUIPPED WITH SUCH MODULES, AND HEADLIGHT ASSEMBLY

(71) Applicant: VALEO VISION, Bobigny Cedex (FR)

(72) Inventors: Pierre Albou, Paris (FR); Vincent Godbillon, Paris (FR)

(21) Appl. No.: 14/888,250

(22) PCT Filed: May 28, 2014
(86) PCT No.: PCT/EP2014/061193

§ 371 Date: Oct. 30, 2015

(30) Foreign Application Priority Data
May 30, 2013 (FR) 1354909

(51) Int. Cl. F21S 8/10; B60Q 1/04

(52) U.S. Cl. CPC F21S 48/1317; B60Q 1/04; F21S 48/1225; B60Q 2300/42

(57) ABSTRACT

A lighting module for a motor vehicle headlight, comprising at least one light source and optical means for forming a light pattern, or pixel, comprising an area illuminated according to a vertical light strip delimited by two vertical edges; the optical means are provided to also form at least one light strip transversal to the vertical light strip, with at least two transverse edges, such that the light pattern comprises at least one vertical strip and at least one transverse strip.

The invention relates to a lighting module for a motor vehicle headlight, a module of the kind of those which comprise at least one light source and optical means for forming a light pattern, or pixel, comprising a zone illuminated along a vertical light strip delimited by two vertical edges.

EP2278217 discloses a lighting module for a motor vehicle ensuring such a function which makes it possible to ensure, in the motor vehicle domain, a “partial main beam mode”. The headlight of the vehicle is equipped with a number of modules which give a light beam, notably a main beam, made up of a number of adjacent and contiguous vertical strips. By switching off one or more of these vertical strips, it becomes possible to generate, in a main beam, one or more dark bands corresponding to points where there are oncoming vehicles or vehicles moving in front of the vehicle concerned, so as to avoid dazzling the other drivers while illuminating the road on either side of the vehicles which are passing by or which are in front. Such a function is called ADB (Adaptive Driving Beam) or GFHB (Glare Free High Beam).

A headlight equipped with such modules makes it possible to retain a lighting over a large road surface area, which is favorable to the driving.

The light beam made up of a number of vertical strips is generally called “matrix beam”. The pattern formed by the lighting strip is often called “pixel”.

When passing an oncoming vehicle, in particular one substantially at the same height as the vehicle concerned, the switching off of one or more strips of the light beam generally leads to a loss of light above the oncoming vehicle, which is a nuisance for the driving.

In the context of a hilly road, the switching off of at least one strip of the beam, to avoid dazzling oncoming vehicles or vehicles being followed, can lead to a loss of light nearby and to inadequate lighting on the nearby part of the road, which is also a nuisance for the driving.

Lighting assemblies are, moreover, known that have a left headlight and a right headlight, with a matrix of light sources, notably of LEDs, the beam of which is broken down into a matrix of a large number of zones which are illuminated independently (more than a hundred usually), the illumination of each zone being generated by at least one light source, generally two, one for each headlight. The large number of sources necessary and the complexity of the associated driving of the switching on of these sources makes such assemblies extremely costly to produce.

The aim of the invention is, above all, to provide a lighting module which makes it possible, simply and economically, to construct motor vehicle headlights and lighting assemblies suitable for retaining, in most cases, a lighting above and/or below an oncoming vehicle, or a vehicle being followed, regardless of the context of the road where the vehicles are moving.

According to the invention, a lighting module for a motor vehicle headlight, of the kind concerned, is characterized in that the optical means are provided or arranged to also form at least one light strip transversal to the vertical light strip, with at least two transverse edges, such that the light pattern comprises at least one vertical strip and at least one transverse strip which are contiguous.

Preferably, the transverse light strip is substantially at right angles to the vertical light strip.

According to an exemplary embodiment, the transverse light strip is the point of origin for at least one of the ends of the vertical strip.

The transverse light strip is advantageously situated at the top end of the vertical light strip and extends on the right side or on the left side of the vertical strip, to form an inverted L turned to the right or to the left.

According to another possibility, the light pattern is made up of a vertical light strip with, at each end of the vertical light strip, a transverse light strip which extends in opposite directions, that is to say one to the left and the other to the right.

According to another possibility, the light pattern comprises a vertical light strip, and on both sides of the top end of the vertical light strip, a horizontal light strip.

The light pattern can comprise a vertical light strip with, at its top end, a transverse light strip, of which the end remote from the vertical light strip joins another, upwardly directed, vertical light strip. In such a case, the light pattern comprises, for example, two vertical light strips and at least one transverse light strip, notably horizontal.

Advantageously, the transverse light strip extends over a distance equal to the width of the vertical light strip.

The optical means for forming a pattern with at least one vertical light strip and at least one transverse light strip can comprise a reflector which receives the light emitted by the source and reflects the light toward a projection device, notably a lens, situated in front of the reflector, a bottom reflecting portion being arranged in the bottom part of the reflector, the profile of this reflecting portion being modified to exhibit, on one edge, an area that is concave toward the front and curved toward the optical axis of the lighting module, the reflecting surface of this portion, turned toward the lens, being determined to create the transverse light strip of the light pattern. The reflector can be of cylindrical or parabolic type.

According to another possibility, the optical means for forming a pattern with at least one vertical light strip and at least one transverse light strip comprise an elliptical reflector which receives the light emitted by the source arranged at a first focal point of the reflector, which returns the light forward toward a second focal point where a mask is arranged in a plane orthogonal to an optical axis of the lighting module, this mask comprising an aperture whose form corresponds to that of the light pattern that the lighting module must generate, and a focusing lens whose focal point is merged with the second focal point of the reflector.

Preferably, the light source is a light-emitting diode. It can also be a laser source combined with a substrate carrying a luminophore.

The invention also relates to a motor vehicle headlight comprising a first lighting module for forming, advantageously only, a vertical central light strip, and at least one second lighting module comprising any one of the preceding features, for forming, on one side of this central light strip formed by the first lighting module, a light pattern with at least one transverse light strip which extends in one direction, and at least one third lighting module provided to form, on the other side of the central light strip formed by the first lighting module, a light pattern symmetrical to the pattern formed by the second lighting module relative to the central light strip formed by the first lighting module.

Preferably, the headlight comprises at least five modules, namely a first lighting module for a central and vertical light strip and, on each side of this first so-called central module, two modules of which at least one supplies light patterns with at least one transverse light strip. More preferentially, the headlight comprises at least seven modules, namely a first lighting module for a central and vertical light strip and, on each side of this first so-called central module, three modules, of which at least two provide light patterns with at least one transverse light strip.

Advantageously, the headlight comprises nine modules, namely a first lighting module for a central and vertical light strip and, on each side of this first so-called central module, four modules, of which at least three provide light patterns with at least one transverse light strip.

The invention also relates to the assembly of a right headlight and a left headlight of a motor vehicle as defined previously, characterized in that the right headlight and the left headlight are combined for their beams to be combined and/or be overlaid so as to form a lighting beam projected onto the road taken by the vehicle.

Advantageously, and as is illustrated later, the orientation of the light patterns with at least one transverse strip relative to the central light strip is in opposite directions between the left and right headlights. The number of zones which can be illuminated independently is thus greatly improved compared to a configuration in which the left and right headlights have the same distribution of light patterns.

The invention described here makes it possible to retain a lighting above and/or below an oncoming vehicle or a vehicle being followed and obtain a motor vehicle lighting assembly of matrix type with a reduced number or content of light sources.

The invention consists, apart from the provisions explained hereinabove, of a certain number of other arrangements that will be more explicitly involved hereinbelow with regard to exemplary embodiments described with reference to the attached drawings, but which are in no way limiting.

In the drawings:

FIG. 1 is a diagram of a light beam of right side “matrix beam” type made up of a number of pixels formed in vertical strips and transverse strips according to the invention.

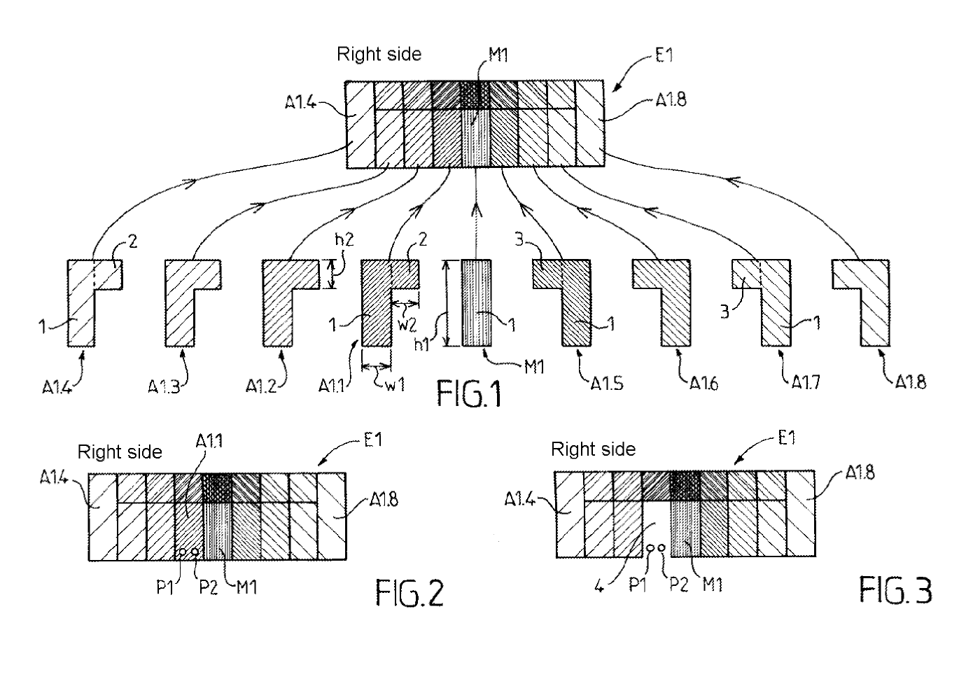

FIG. 2 is a diagram of the beam of FIG. 1 with detection of headlights of a vehicle coming at the bottom in the reverse direction.

FIG. 3 represents the beam of the headlight after the nuisance light strip for the oncoming vehicle has been switched off.

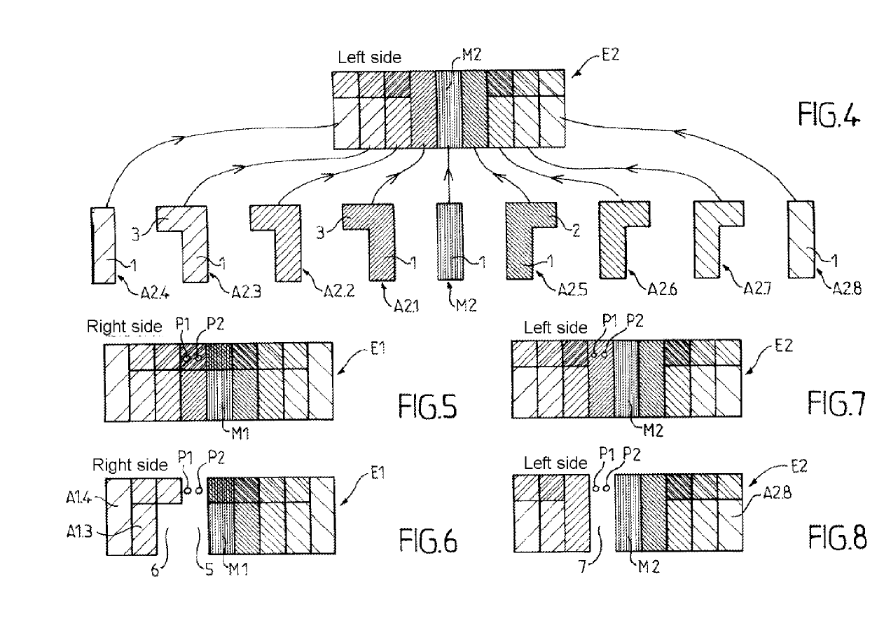

FIG. 4 illustrates, similarly to FIG. 3, a left side light beam and the pixels that make it possible to obtain this beam.

FIG. 5 illustrates the light beam from the right side headlight of the vehicle when headlights of an oncoming vehicle are detected in the high part of the beam.

FIG. 6 illustrates the beam on the right side of the vehicle after pixels which might have caused a nuisance for the oncoming vehicle have been switched off.

FIG. 7 illustrates, similarly to FIG. 5, the beam from the left side headlight with detection of the headlights of the vehicle to be passed.

FIG. 8 illustrates the beam from the left side headlight after the pixel that might be a nuisance for the oncoming driver has been switched off.

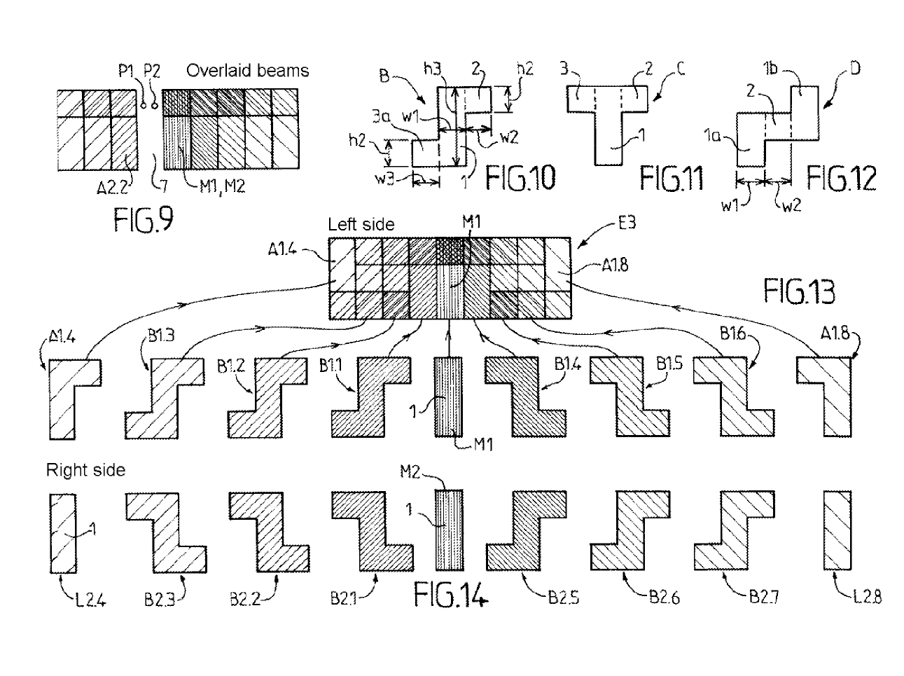

FIG. 9 illustrates the overall beam obtained by overlaying of the right side beam of FIG. 6 and the left side beam of FIG. 8.

FIGS. 10 to 12 illustrate various possible pixel forms.

FIG. 13 illustrates a light beam from a headlight siguated on the left side of the vehicle made up of pixels of the type according to FIG. 10.

FIG. 14 illustrates inverted pixels for the headlight situated on the right side of the vehicle in combination with the beam of FIG. 13.

FIG. 15 illustrates the right side beam obtained with pixels of FIG. 14.

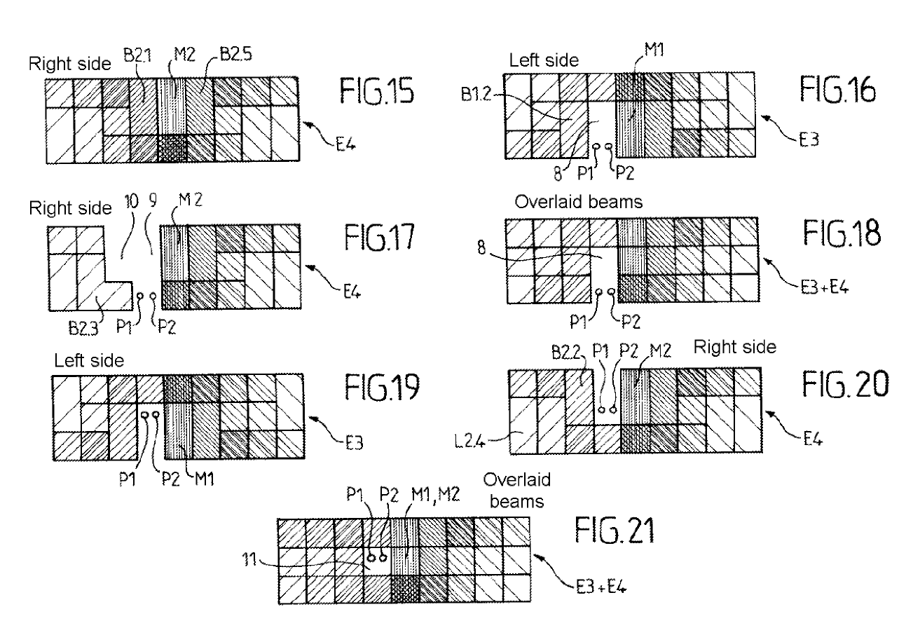

FIG. 16 illustrates the left side light beam with a pixel switched off, when an oncoming vehicle at substantially the same level is detected.

FIG. 17 illustrates the right side beam, with two pixels switched off, to avoid a nuisance for the oncoming driver.

FIG. 18 illustrates the overall beam of the vehicle obtained by overlaying of the beam of FIG. 16 and the beam of FIG. 17.

FIG. 19 illustrates the left side beam when a mid-height vehicle is oncoming.

FIG. 20 illustrates the right side beam for the same vehicle passing conditions as in FIG. 19.

FIG. 21 illustrates the overall beam obtained by overlaying of the left side beam of FIG. 19 and the right side beam of FIG. 20.

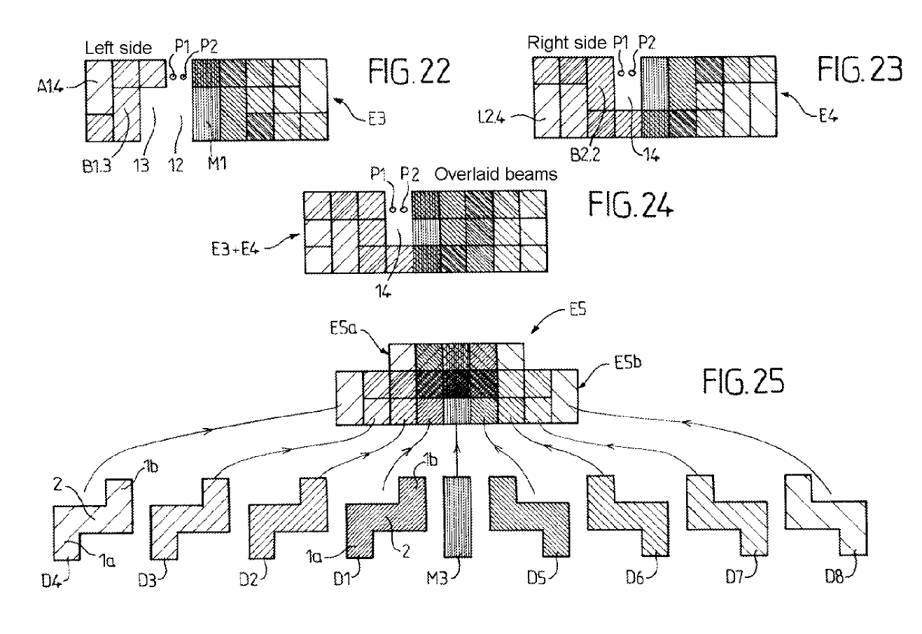

FIG. 22 illustrates the left side beam obtained, from the beam of FIG. 13, by switching off the pixels likely to be a nuisance for the driver of a high oncoming vehicle.

FIG. 23 is a diagram illustrating the right side beam for the same case of a high oncoming vehicle.

FIG. 24 illustrates all of the beam obtained by overlaying of the left side beam of FIG. 22 and the right side beam of FIG. 23.

FIG. 25 illustrates another type of light beam obtained with pixels of the type of that of FIG. 12.

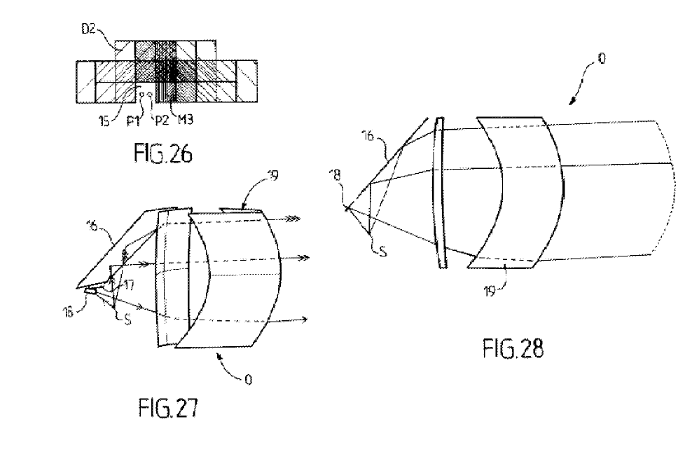

FIG. 26 illustrates the beam according to FIG. 25 with a strip switched off to pass a low oncoming vehicle.

FIG. 27 is a simplified perspective diagram of optical means that make it possible to obtain an inverted L-shaped pixel illustrated in FIG. 29.

FIG. 28 is a vertical cross section of the optical means of FIG. 27 with the path of light rays.

FIG. 29 is an illustration of the photometry of the pixel obtained with a module equipped with the optical means of FIGS. 27 and 28.

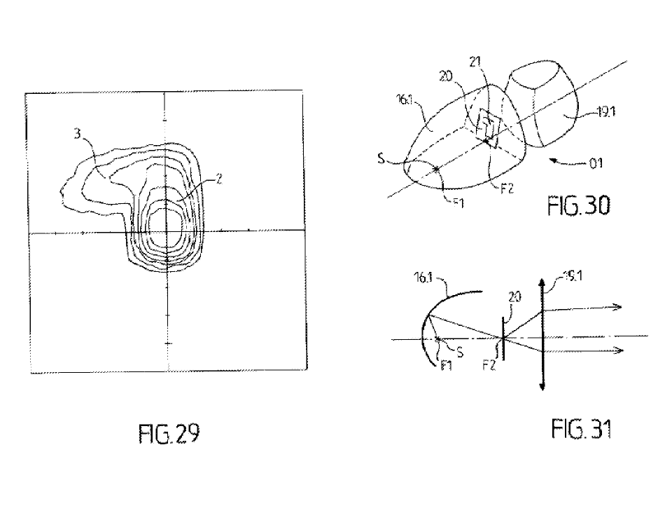

FIG. 30 illustrates, by simplified perspective, other optical means, with mask, that make it possible to obtain a pixel of the type of that of FIG. 1, and

FIG. 31 is a schematic vertical cross section, passing through the optical axis, of the optical means of FIG. 30.

Referring to FIG. 1 of the drawings, a light beam E1 can be seen, schematically represented in the form of a rectangle, provided by a motor vehicle headlight, notably the headlight situated on the right side of the vehicle. The beam E1 corresponds, preferably, to a high beam with a range of several hundred meters, notably of the order of 500 m.

The beam E1 is obtained using a number of lighting modules, an exemplary embodiment of which will be described with respect to FIGS. 27 and 28, as well as another example with respect to FIGS. 30 and 31.

Each lighting module comprises at least one light source S (FIGS. 27, 28 and 30, 31) and optical means O (FIG. 27, 28) or O1 (FIG. 30, 31) to form an illuminated zone comprising a vertical light strip 1 delimited by two sharp vertical edges.

The optical means are provided to also form at least one transverse light strip 2, 3 according to FIG. 1, substantially at right angles, at at least one of the ends of the vertical strip 1. The transverse edges of the strip 2 or 3 are relatively sharp, or totally sharp. They can notably extend in a horizontal direction. According to the example of FIG. 1, the transverse light strips 2, 3 are provided at the top end of the vertical light strip 1, and are turned respectively to the right and to the left of the vertical light strip 1.

The beam E1 is obtained using nine modules. A central module gives a light strip M1 made up of the vertical rectangular strip 1. This central module, also called first lighting module, can be arranged to form only a vertical light strip. On the left side of the central module there are four modules each producing a light pattern A1.1-A1.4 which comprises a vertical rectangular light strip 1 and, at its top end, a transverse light strip 2 turned to the right toward the central pattern M1. The light pattern is continuous between the vertical light strip 1 and the transverse light strip 2 such that this pattern is in the form of an inverted L. Advantageously, the width w1 of the vertical light strip 1 is equal to the horizontal dimension w2 of the transverse light strip 2. Preferably, the height h1 of the vertical light strip 1 is equal to three times the height h2 of the transverse light strip 2 or 3.

The patterns A1.5-A1.8 situated on the right are symmetrical to the left hand patterns relative to the central pattern M1. The patterns A1.5-A1.8 thus have a horizontal light strip 3 turned to the left toward the central pattern M1.

The patterns of the nine modules are juxtaposed contiguously along the vertical edges of the vertical light strips 1, to give the beam E1.

The beam is thus made up of strips that include a bend.

The optical means that make it possible to establish the light pattern produced by each module are arranged and positioned in such a way that the pattern M1 is situated at the center of the beam E1 on the optical axis of the lighting module; the adjacent pattern on the left A1.1 is positioned, by the right edge of its vertical light strip, against the vertical left edge of the pattern M1, without leaving any space. The transverse light strip 2 of the pattern A1.1 covers the corresponding top zone of the vertical light strip 1, preferably without extending beyond this strip.

Similarly, the left pattern A1.5 is adjacent, without space, by the left edge of its vertical light strip, with the right edge of the pattern M1. The transverse light strip 3 of the pattern A1.5 covers the top end of the pattern M1, which may already be covered by the transverse light strip 2 of the pattern A1.1.

The other light patterns are arranged similarly such that their vertical light strips are contiguous with the vertical light strips of the patterns on either side of them. The transverse light strip of a pattern covers the top end of the vertical light strip of the neighboring pattern closer to the central pattern M1.

Each module is controlled individually by means that are not represented and that are sensitive to the presence of one or more vehicles which may be oncoming to the vehicle concerned, or of one or more vehicles traveling in the same direction but in front of the vehicle concerned. These sensitive means are designed to switch off the respective module or modules whose light patterns may be a nuisance to the oncoming drivers or drivers traveling in front of the vehicle concerned.

These means are generally sensitive to the light emitted by the headlights P1, P2 (FIGS. 2 and 3) of an oncoming vehicle, or by the signaling lights of a vehicle running in front. Other means sensitive to the presence of oncoming vehicles or vehicles in front could be used such as radars, that are generally more costly.

According to the example of FIG. 2, an oncoming vehicle is detected in low position, in a zone illuminated by the vertical light strip of the pattern A1.1 situated immediately to the left of the central pattern M1 of the “matrix beam”. The sensitive means control the switching off of the lighting module producing the pattern A1.1 such that the beam El is modified as illustrated in FIG. 3 and has a dark strip, or window, 4, containing the oncoming vehicle, which avoids dazzling its driver. The dark strip 4 has a height less than the height of the beam E1 because the horizontal transverse part 2 of the pattern A1.2, situated immediately to the left of the eliminated pattern A1.1, makes it possible to retain light above the oncoming vehicle.

FIG. 4 is a diagram similar to that of FIG. 1 illustrating the definition of the headlight situated on the other side of the vehicle, that is to say situated on the left side inasmuch as FIG. 1 corresponds to the right side headlight.

The “matrix beam” E2 is made up of nine patterns originating from nine lighting modules, with a central pattern M2 consisting of a vertical light strip 1, advantageously unique. To the left of the pattern M2, there are three patterns A2.1, A2-2, A2.3 having a bend formed by a transverse light strip 3 turned to the left, on the side opposite the central pattern M2. The pattern A2.4 situated to the extreme left of the beam E2 is made up of a vertical light strip 1.

The four light patterns situated to the right of the central pattern M2, and produced by four corresponding lighting modules, are symmetrical to the patterns situated on the left relative to the central module M2.

The right and left headlights of the vehicle are set such that the beam E2 is combined with and/or overlaid on the beam E1 of FIG. 1.

If a vehicle arrives in the reverse direction and is detected as illustrated in FIG. 5 by its headlights P1, P2 situated in a zone corresponding to the high part of the pattern A1.1 of FIG. 1 situated immediately to the left of the central pattern M1, the lighting module producing the pattern A1.1 is switched off, as is the lighting module situated immediately to the left A1.2 whose transverse light strip 2 was illuminating the high part.

The result thereof is that the beam E1, as illustrated in FIG. 6, comprises a vertical dark strip 5 over the entire height of the beam. A dark strip 6, of reduced height like the strip 4 of FIG. 3, widens the dark zone to the left. The transverse light strip 2 of the pattern A1.3 remains above the strip 6, without being a nuisance to the oncoming driver, which makes it possible to improve the vision of the driver of the vehicle equipped with the invention.

The dark strip 6 reduces the lighting of the road for the driver of the vehicle concerned.

The left headlight whose initial beam E2 is illustrated in FIG. 7 gives, after detection of the oncoming vehicle, the modified beam E2 of FIG. 8 in which the pattern A2.1 of FIG. 4, situated immediately to the left of the central pattern M2, is switched off. The result thereof is a vertical dark strip 7 over the entire height of the beam. Because the transverse light strip 3 of the neighboring pattern A2.2 on the left is directed to the left, this pattern A2.2 can remain switched on without being a nuisance to the oncoming driver.

The combination or the overlaying of the beams of the right headlight and the left headlight, as illustrated in FIG. 9, makes it possible to obtain a beam in which the dark strip 6 of FIG. 6 is canceled by the vertical light strip of the pattern A2.2 of FIG. 8, which improves the lighting of the road for the driver of the vehicle concerned. Only the vertical strip 7 around the oncoming vehicle is dark.

FIGS. 10-12 illustrate other possible forms of light patterns or pixels for producing a lighting beam by juxtaposition of a number of patterns.

According to FIG. 10, the light pattern B comprises a vertical light strip 1 comprising, at its top end, a transverse light strip 2 extending to the right, and at its bottom end a transverse light strip 3a extending at right angles to the left. The width w1 of the strip 1 is equal, as in the case of the preceding FIGS. 1 and 4, to the horizontal extent w2, w3 of the transverse light strips 2, 3a. The pattern B resembles the letter S, in the form of a straightened S.

This form is particularly preferable.

FIG. 11 illustrates another possible light pattern C corresponding substantially to a T form. The pattern C comprises the vertical light strip 1, in its central part. A transverse light strip 2 extending to the right and a transverse light strip 3 extending to the left are provided respectively on each side of the top end of the strip 1. The transverse extent of the strips 2, 3 is equal to the width of the strip 1.

FIG. 12 illustrates another possible form D for the pixel or light pattern. The pattern D comprises a vertical illuminated strip 1a of height less than that of the strips 1 of the preceding patterns. A transverse light strip 2 adjacent to the top end of the strip 1a extends to the right by a transverse distance w2 equal to the width w1 of the strip 1a. A vertical light strip 1b adjacent to the right end of the transverse light strip 2 extends upward. The vertical light strip 1b is symmetrical to the vertical light strip 1a relative to the center of the transverse light strip 2.

Obviously, other patterns are possible, notably patterns that are symmetrical relative to a vertical or horizontal axis passing through the center of the patterns B or D. By way of example, the pattern can form an H or a cross “+”.

FIG. 13 illustrates a beam E3 obtained with a left vehicle headlight comprising nine lighting modules which generate the lighting patterns or pixels reproduced in exploded form below the beam E3. A central pattern M1 is formed by a vertical light strip.

To the left of the central pattern M1, there are three successive patterns B1.1, B1.2, B1.3 similar to the pattern B of FIG. 10. The last pattern to the left A1.4 consists of a vertical light strip comprising, at its top end, a transverse light strip turned to the right in the direction of the central pattern M1.

The patterns B1.4-B1.6 and A1.8 situated to the right of the central pattern M1 are symmetrical to the patterns situated on the left, relative to this central pattern.

The optical means of each module are designed to juxtapose the vertical light strips of the different patterns and obtain the beam E3.

FIG. 14 illustrates, in exploded form, the patterns or pixels of the right headlight which gives the beam E4 of FIG. 15. As can be seen in FIG. 14, the central pattern M2 is a vertical rectangular light strip. On each side of this central pattern, there are three patterns, respectively B2.1-B2.3 and B2.5-B2.7, inverted relative to those of FIG. 13, that is to say that the patterns B2.1-B2.3 situated to the left of the central pattern M2 correspond to the patterns B1.4-B1.6 situated to the right of the central pattern M1 according to FIG. 13. The same applies for the right-hand part of FIG. 14 and the left-hand part of FIG. 13.

The two pixels L2.4-L2.8 at the left and right ends of FIG. 14 consist of vertical rectangular light strips.

The vertical edges of the successive strips of FIG. 14 are contiguous in the beam E4, as can be seen in FIG. 15.

As illustrated in FIG. 16, when an oncoming vehicle is detected, notably by its headlights P1, P2, situated in the low zone to the left of the pattern M1, the pattern B1.1 of FIG. 13 is switched off so that the oncoming vehicle is in a vertical dark strip 8, which avoids dazzling its driver. The strip 8 has a height less than that of the beam E4 because the horizontal light strip turned to the right of the adjacent pattern B1.2 (FIG. 13) continues to illuminate the road above the oncoming vehicle situated in the low part. This lighting of the high part improves the conditions for driving.

FIG. 17 schematically illustrates the beam E4 modified to avoid dazzling the oncoming driver. The pattern B2.1 (FIG. 14) situated immediately to the left of the central pattern M2 is switched off, which generates the vertical dark strip 9 over the entire height of the beam E4. The pattern immediately adjacent to the left B2.2 is also switched off for its bottom transverse strip not to illuminate the zone in which the oncoming vehicle is located. The result thereof is an additional dark strip 10 of height less than that of the beam E4.

When the two beams E3 and E4 are overlaid as illustrated in FIG. 18, the dark strip 10 disappears and a configuration similar to that of FIG. 16 is restored.

FIGS. 19-21 illustrate the modifications made to the beams of FIGS. 13 and 15 when an oncoming vehicle is situated substantially at mid-height, identified by its headlights P1, P2. FIG. 19 illustrates the modified beam E3 for the left headlight. The configuration of FIG. 16 is restored.

For the right headlight, as illustrated by FIG. 20, the configuration of the beam is different from that of FIG. 17 because only the pattern B2.1 immediately to the left of the central pattern M2 is switched off. By contrast, the pattern B2.2, immediately to the left of B2.1, remains switched on because it bottom transverse light strip is situated under the oncoming vehicle.

FIG. 21 schematically illustrates the overall beam obtained by the overlaying of the left and right beams of FIGS. 19 and 20. The non-illuminated zone 11 in which the oncoming vehicle is located lies between a high illuminated zone corresponding to the top transverse light strip of the pattern B1.2 of FIG. 13, and an illuminated low zone corresponding to the bottom transverse strip of the pattern B2.2 (FIG. 14) of the right headlight.

The lighting of the zones situated respectively above and below the oncoming vehicle constitutes an improvement for the visibility of the driver.

FIGS. 22-24 illustrate the case of an oncoming vehicle, high, as represented schematically by the headlights P1, P2, immediately to the left of the central pattern M1.

For the left headlight, as illustrated in FIG. 22, the pattern B1.1, situated immediately to the left of the central pattern M1, is switched off, but also the pattern B1.2 (FIG. 13) situated to the left of the pattern B1.1, to avoid having the zone P1, P2 illuminated by the top transverse light strip of the pattern B1.2. The result thereof is a dark zone 12 of a height equal to that of the beam with, immediately to the left, a dark zone 13 of lesser height.

FIG. 23 illustrates the modification of the beam E4 of the right headlight. The pattern B2.1 (FIG. 14) situated immediately to the left of the central pattern M2 is switched off. By contrast, the pattern B2.2, to the left of the pattern B2.1, remains switched on and its bottom transverse light strip illuminates the zone of the road below the oncoming vehicle. The vertical dark strip 14 has a height less than that of the beam.

FIG. 24 illustrates the overall beam obtained by overlaying of the beams of FIG. 22 and FIG. 23. The dark strip 13 of FIG. 22 has disappeared. The oncoming vehicle is in the dark strip 14 of FIG. 23, the bottom part of which is illuminated, which facilitates the driving.

FIG. 25 schematically illustrates a light beam E5 obtained with a headlight comprising nine lighting modules giving the light patterns represented in exploded fashion in the bottom part of FIG. 25. The central pattern M3 still consists of a vertical rectangular light strip. To the left of this pattern, there are four patterns D1-D4 similar to the pattern D of FIG. 12. The patterns D5-D8 situated to the right of the central pattern M3 are symmetrical to the patterns D1-D4 relative to the central pattern.

The beam E5, obtained by making the vertical edges of the bottom part of the vertical light strips la contiguous, has a top part E5a narrower than its bottom part E5b. According to the embodiment of the patterns D, notably with a transverse light strip 2 whose height is equal to the height of the protruding vertical parts 1a, 1b, the height of the bottom zone E5b is equal to twice the height of the top part E5a of the beam.

As illustrated in FIG. 26, in the case of an oncoming vehicle, low, the pattern D1 contiguous with the left edge of the central module M3 is switched off. The other patterns remain switched on such that the light is removed just around the oncoming vehicle, in a zone 15 of height just sufficient to avoid dazzling the oncoming driver. A significant illuminated zone remains above the vehicle.

FIG. 27 schematically illustrates, in perspective, optical means O of a lighting module for producing a light pattern or pixel, the simulated photometry of which is illustrated according to FIG. 29, which represents the isolux curves corresponding to a lighting which decreases from the central zone outward. The light pattern of FIG. 29 comprises a substantially rectangular vertical light strip 1 and a transverse light strip 3 that is substantially horizontal and turned to the left, like the patterns A1.5-A1.8 of FIG. 1.

The light source S is notably formed by an LED (light-emitting diode). It can also be a laser source directed toward a substrate carrying a luminophore. The light rays are then formed by the activation of the luminophore by the laser source.

The light emitted by the source S is directed toward a reflector 16, notably parabolic or cylindrical, inclined from bottom to top toward the front. In the bottom part of the reflector 16, there is a reflecting portion which, over a part 17 of its extent, from a longitudinal edge of the reflector 16, substantially extends the surface area of this reflector. Toward its other end, the part 17 is concavely curved toward the front according to a section 18. The reflecting surface of this section 18, turned toward the front, is determined to obtain the transverse branch 3 of the pixel of FIG. 29, extending to the left of the vertical light strip.

A focusing device consisting of a lens 19 having a convex front face and rear face that is substantially planar or slightly convex toward the rear is arranged in front of the reflector 16. The focal point of the lens 19 is in the vicinity of a mask 20. The beam of rays outgoing from the lens 19, as illustrated in FIG. 28, essentially consists of parallel light rays. However, the light rays originating from the source S and falling on the section 18 are reflected toward the bottom part of the lens and exit therefrom in an upward direction to form the transverse light strip 3 of FIG. 29.

To obtain a light pattern whose transverse light strip would be turned to the right instead of being turned to the left according to FIG. 29, a curved zone, such as the section 18, of the bottom strip of the reflector, would be provided on the other edge of the part 17.

FIGS. 30 and 31 schematically illustrate another embodiment of optical means O1 for producing the pixels or light patterns described previously.

These optical means O1 comprise an elliptical reflector 16.1 open toward the front where there is a lens 19.1 for focusing the light beam. The light source S is situated at a first focal point F1 of the reflector 16.1. In the plane orthogonal to the optical axis and passing through the second focal point F2 of the reflector 16.1, there is a mask 20 in which an aperture 21 is provided with a form corresponding to that of the pattern or pixel that the lighting module must generate. According to the example of FIG. 30, the aperture 21 corresponds to a pixel with vertical strip and right-angled bend. The focal point of the lens 19.1 is merged with the second focal point F2 of the elliptical reflector, the optical axis of which is common to that of the lens 19.1. The lens 19.1 provides an image at infinity of the aperture 21, forming the desired pixel or pattern.

FIG. 31 is a diagram in vertical cross section passing through the optical axis of the lighting module illustrating the path of light rays from the source S, reflected by the reflector 16.1 and refracted by the lens 19.1 to give an essentially parallel beam corresponding to the desired pattern.

It will be well understood that the exemplary configurations given with nine modules make it possible to generate, from 18 light sources (1 source per module and per headlight) a lighting beam with, notably, 15 zones which can be illuminated independently (configuration of FIG. 1 to 9) or 27 zones (configurations of FIGS. 13 to 24) depending on the form of the patterns with transverse strip applied, which is highly advantageous compared to a matrix lighting assembly in which the total number of sources necessary is generally twice that of the independent zones, with a duplication in each headlight, unless sources of very high light power are used, which are much more expensive.

The invention makes it possible to produce a beam of matrix type with overlaying of the beams of the right headlight and of the left headlight according to which, in most cases, light is maintained above or below the vehicle being passed or followed, which greatly improves the driving conditions compared to a vehicle equipped with matrix beam headlights with juxtaposed vertical strips, while still of a contained design cost.

The qualifiers top, bottom, high, low, left and right described above apply relative to a vertical direction and either side thereof.

1. A lighting module for a motor vehicle headlight, comprising at least one light source (S) and optical means (O, O1) for forming a light pattern, comprising an area illuminated according to a vertical light strip delimited by at least two vertical edges, wherein said optical means (O, O1) are arranged to also form at least one transverse light strip transversal to said vertical light strip, with at least two transverse edges, such that said light pattern comprises at least one vertical strip and at least one transverse strip which are contiguous.

2. The lighting module as claimed in claim 1, wherein said transverse light strip is substantially at right angles to said vertical light strip.

3. The lighting module as claimed in claim 1, wherein said transverse light strip is the point of origin for at least one of the ends of said vertical light strip.

4. The lighting module as claimed in claim 3, wherein said transverse light strip is situated at the top end of said vertical light strip and extends on the right side or on the left side of said vertical light strip, to form an inverted L turned to the right or to the left.

5. The lighting module as claimed in claim 3, wherein a light pattern (B) is made up of said vertical light strip with, at each end of said vertical light strip said transverse light strip which extends in opposite directions.

6. The lighting module as claimed in claim 3, wherein a light pattern (C) comprises said vertical light strip, and on both sides of top end of said vertical light strip, a horizontal light strip.

7. The lighting module as claimed in claim 3, wherein a light pattern (D) comprises said vertical light strip with, at its top end, said transverse, light strip, of which the end remote from said vertical light strip joins another, upwardly directed, vertical strip.

8. The lighting module as claimed in claim 1 wherein said transverse light strip extends over a distance (w2) equal to a width (w1) of said vertical light strip.

9. The lighting module as claimed in claim 1, wherein said optical means (O) for forming a pattern with at least one of said vertical light strip and at least one of said transverse light strip comprise a reflector which receives the light emitted by said at least one light source (S) and reflects the light toward a lens situated in front of said reflector, a bottom reflecting portion being provided in a bottom part of said reflector, the profile of said bottom reflecting portion being modified to exhibit, on one edge, an area that is concave toward the front and curved toward an optical axis of said lighting module, a reflecting surface of said bottom reflecting portion, turned toward said lens, being determined to create said transverse light strip (2, 3, 3a) of the light pattern.

10. The lighting module as claimed in claim 9, wherein said reflector is cylindrical or parabolic.

11. The lighting module as claimed in claim 1 wherein said optical means (O1) for forming a pattern with at least one of said vertical light strip and at least one of said transverse light strip comprise an elliptical reflector which receives the light emitted by said at least one light source (S) arranged at a first focal point (F1) of said elliptical reflector, which returns the light forward toward a second focal point (F2) where a mask is arranged in a plane orthogonal to an optical axis of said lighting module, said mask comprising an aperture whose form corresponds to that of the light pattern that said lighting module must generate, and a focusing lens whose focal point is merged with said second focal point (F2) of said elliptical reflector.

12. The lighting module as claimed in claim 1, wherein said at least one light source (S) is a light-emitting diode.

13. The lighting module as claimed in claim 1, wherein said at least one light source (S) is a combination of a laser source and a luminophore.

14. A motor vehicle headlight comprising a plurality of lighting modules, a first lighting module is provided to form, advantageously only, a vertical central light strip (M1, M2, M3), that at least one second lighting module as claimed in claim 1 is provided to form, on one side of said central light strip (M1, M2, M3), a light pattern (A, B, C, D) with at least one transverse light strip which extends in one direction, and that at least one third lighting module is provided to form, on the other side of said central light strip (M1, M2, M3) formed by said first lighting module, a light pattern symmetrical to the pattern formed by said second lighting module relative to the-said central light strip (M1, M2, M3) formed by said first lighting module.

15. An assembly of a right headlight and a left headlight of a motor vehicle, as claimed in claim 14, wherein said right headlight and said left headlight are combined for their beams to be combined and/or be overlaid so as to form a lighting beam projected onto the road taken by said motor vehicle.

16. The lighting module as claimed in claim 2, wherein said transverse light strip is the point of origin for at least one of the ends of said vertical light strip.

17. The lighting module as claimed in claim 4, wherein a light pattern (C) comprises said vertical light strip, and on both sides of the top end of said vertical light strip, a horizontal light strip.

18. The lighting module as claimed in claim 4, wherein a light pattern (D) comprises said vertical light strip with, at its top end, said transverse light strip, of which the end remote from said vertical light strip joins another, upwardly directed, vertical strip.

19. The lighting module as claimed in claim 2, wherein said transverse light strip extends over a distance (w2) equal to a width (w1) of said vertical light strip.

20. The lighting module as claimed in claim 3, wherein said transverse light strip extends over a distance (w2) equal to a width (w1) of said vertical light strip.
